(19) United States
(12) Patent Application Publication
(10) Pub. No.: US 2025/0296376 A1
(43) Pub. Date: Sep. 25, 2025

(54) PRINTING DEVICE

(71) Applicant: SEIKO EPSON CORPORATION, Tokyo (JP)

(72) Inventors: Yutaka NAGASHIMA, MATSUMOTO-SHI (JP); Satoru MIYAMOTO, MATSUMOTO-SHI (JP); Daisuke HIRUMA, MATSUMOTO-SHI (JP)

(21) Appl. No.: 19/084,293

(22) Filed: Mar. 19, 2025

(30) Foreign Application Priority Data
Mar. 22, 2024 (JP) 2024-046162

(51) Int. Cl. B41J 29/377; B41J 29/13

(52) U.S. Cl. CPC B41J 29/377; B41J 29/13

(57) ABSTRACT

A printing device 1 includes a head 25 that is accommodated in a housing 100 and ejects ink onto a medium 2; an opening and closing cover 200 that includes a first partition 210 constituting a part of a top surface 100a of the housing 100 and a second partition 220 constituting a part of a front surface of the housing 100 that opens and closes the top surface 100a of the housing 100; a suction section 240 that sucks gas inside the housing 100 from a suction hole 241; and a duct 231 that communicates with the suction section 240, wherein the duct 231 is fixed to an outer surface 220f of the second partition 220.

The present application is based on, and claims priority from JP Application Serial Number 2024-046162, filed Mar. 22, 2024, the disclosure of which is hereby incorporated by reference herein in its entirety.

### BACKGROUND

### 1. Technical Field

The present disclosure relates to a printing device.

### 2. Related Art

JP-A-2018-176455 discloses an inkjet printer that is an example of a printing device including a platen on which a recording medium is supported, an ink head, a transport mechanism, a cover member, a front cover, and a blower device. The ink head is provided so as to be movable in a main scanning direction and ejects ink onto the recording medium. The transport mechanism transports the recording medium in a sub-scanning direction orthogonal to the main scanning direction. The cover member is arranged above and beside the platen, and an opening is formed on a downstream side of the ink head in the sub-scanning direction. The front cover is attached to the cover member and opens and closes the opening. The blower device is provided on the front cover.

In the inkjet printer disclosed in JP-A-2018-176455, the blower device, which is made of aluminum material, is attached to a lower end of the front cover, which is made of transparent acrylic resin. In this case, since the blower device is provided at the lower end of the front cover, there is a possibility that sufficient strength of the front cover cannot be secured.

### SUMMARY

A printing device includes a head that is accommodated in a housing and that ejects liquid onto a medium; an opening and closing cover that includes a first partition constituting a part of a top surface of the housing and a second partition constituting a part of a front surface of the housing, and that opens and closes the top surface of the housing; a suction section that sucks gas inside the housing from a suction hole; and a duct that communicates with the suction section, wherein the duct is fixed to an outer surface of the second partition.

### BRIEF DESCRIPTION OF THE DRAWINGS

FIG. 1 is a schematic diagram showing a configuration of a printing device.

FIG. 2 is a perspective view showing an appearance of the printing device.

FIG. 3 is a perspective view showing a state in which an opening and closing cover of the printing device shown in FIG. 2 is in an opened position.

FIG. 4 is a perspective view showing a configuration around the opening and closing cover when the opening and closing cover is in a closed position.

FIG. 5 is a partial perspective view showing a configuration around the opening and closing cover when the opening and closing cover is in the opened position.

FIG. 6 is a partial perspective view showing a configuration around the opening and closing cover when the opening and closing cover is in the closed position.

FIG. 7 is a perspective view of the opening and closing cover as viewed from a front surface.

FIG. 8 is a perspective view of the opening and closing cover as viewed from a rear surface.

FIG. 9 is a partial perspective view showing a configuration of a suction section and a duct.

FIG. 10 is a partial perspective view showing a configuration of an inner duct and a vertical duct.

FIG. 11 is a partial perspective view showing an other embodiment of the suction section.

### DESCRIPTION OF EMBODIMENTS

Hereinafter, the present disclosure will be described based on an embodiment. In each drawing, the same members are denoted by the same reference symbols, and a duplicate description will be omitted. In the present specification, the terms “same”, “identical”, and “simultaneous” do not necessarily mean that something is completely the same.

For example, in the present specification, “same”, “identical”, and “simultaneous” are terms that include the case of being the same within the scope of measurement error. For example, in the present specification, the terms “same”, “identical”, and “simultaneous” include the case of being the same in consideration of manufacturing variations of members. For example, in the present specification, the terms “same”, “identical”, and “simultaneous” are used to include cases that are the same as long as the function is not impaired. Thus, for example, “both dimensions are the same” means that the dimensional difference between the two is within +5 percent of one dimension, particularly desirably within +3 percent, taking into account measurement errors and manufacturing variations of the member.

### 1. First Embodiment

A printing device 1 is, for example, an inkjet type printer which prints an image such as a character or a photograph on a medium 2 by ejecting ink, which is an example of liquid, onto the medium 2 such as a paper sheet.

In each drawing, X, Y, and Z represent three spatial axes orthogonal to each other. In the present specification, directions along these axes are referred to as an X-axial direction, a Y-axial direction, and a Z-axial direction. In a case where a direction is specified, a positive direction is referred to as “+”, a negative direction is referred to as “−”, positive and negative signs are used together for direction notation, a direction in which an arrow in each drawing is directed is referred to as a +direction, and a direction opposite to the arrow is referred to as a-direction.

The Z-axial direction indicates a gravity direction, a +Z-axial direction indicates a vertically upward direction, and a −Z-axial direction indicates a vertically downward direction. A plane including an X-axis and a Y-axis is described as an X-Y plane, a plane including the X-axis and a Z-axis as an X-Z plane, and a plane including the Y-axis and the Z-axis as a Y-Z plane. The X-Y plane is a horizontal plane. Further, the three spatial axes of X, Y, and Z, which do not limit the positive direction and the negative direction, will be described as the X-axis, the Y-axis, and the Z-axis.

The X-axial direction is a width direction of the printing device 1, a width direction of the medium 2 on which an image is printed, and a width direction of a transport path on which the medium 2 is transported. When viewed from an operator positioned on a front surface of the printing device 1, a +X direction is a left side, and a −X direction is a right side.

The Y-axial direction is a depth direction of the printing device 1 and a direction along a transport direction of the medium 2 during printing. A +Y direction is a direction from a rear surface to a front surface of the printing device 1, and a −Y direction is a direction from the front surface to the rear surface of the printing device 1. In the present embodiment, among side surfaces constituting the periphery of the printing device 1, a side surface in the −Y direction is the rear surface of the printing device 1, and a side surface in the +Y direction is the front surface of the printing device 1.

Hereinafter, a direction in which the medium 2 is transported is referred to as “downstream”, and the opposite direction is referred to as “upstream” in some cases. Hereinafter, viewing from a +Z direction or a −Z direction may be referred to as plane view or planar.

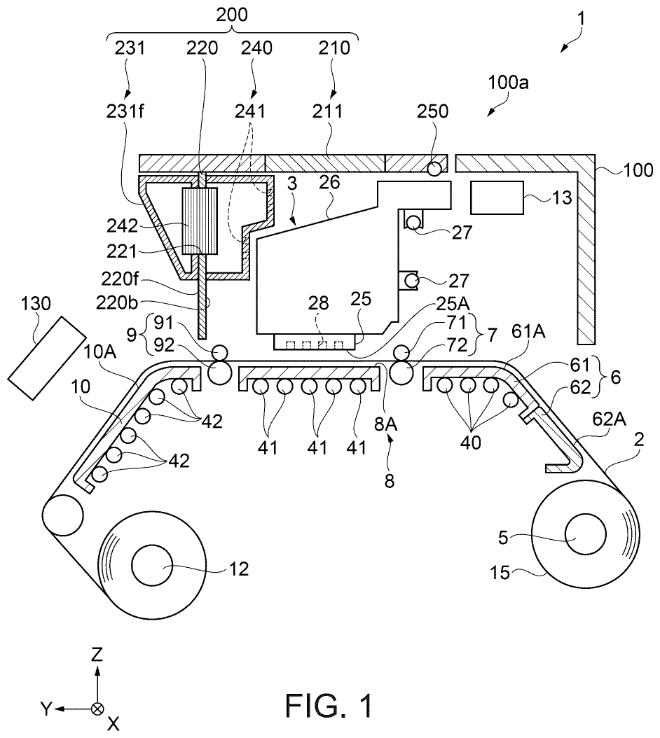

As shown in FIG. 1, the printing device 1 includes a feed shaft 5, an upstream support section 6, an upstream transport section 7, a platen 8, a printing section 3, a downstream transport section 9, a downstream support section 10, and a winding shaft 12. The upstream support section 6, the upstream transport section 7, the platen 8, the downstream transport section 9, and the downstream support section 10 are positioned on a transport path on which the medium 2 is transported.

The printing device 1 further includes upstream heating sections 40, printing heating sections 41, and downstream heating sections 42. The printing device 1 further includes a blower section 130, a control unit 13, and a housing 100.

The feed shaft 5 is a rod-shaped member extending along the X-axial direction. The feed shaft 5 is supported by a frame or the like (not shown) at both end sections in the X-axial direction. The feed shaft 5 rotatably supports a roll 15 on which the elongated medium 2 is wound in a cylindrical shape. The feed shaft 5 feeds the medium 2 from the roll 15 toward the upstream support section 6 by rotating.

The upstream support section 6, the platen 8, and the downstream support section 10 are members that support the medium 2 transported in the transport direction. The medium 2 is transported along surfaces of the upstream support section 6, the platen 8, and the downstream support section 10. A direction along the surfaces of the upstream support section 6, the platen 8, and the downstream support section 10 is the transport direction of the medium 2. The transport direction intersects the X-axial direction. The upstream support section 6, the platen 8, and the downstream support section 10 are fixed to a frame (not shown) or the like that supports the entire printing device 1.

The upstream support section 6 includes an upstream heating support section 61 and an upstream guide support section 62. The upstream support section 6 supports a portion of medium 2 on an upstream side in the transport direction with respect to a portion facing the printing section 3. The platen 8 is positioned downstream of the upstream support section 6 in the transport direction. The medium 2 supported by the upstream support section 6 is transported to the platen 8 by the upstream transport section 7.

The upstream transport section 7 is positioned downstream of the upstream support section 6 in the transport direction. The upstream transport section 7 is positioned upstream of the platen 8 in the transport direction. The upstream transport section 7 includes a first roller 71 and a second roller 72. The first roller 71 and the second roller 72 each extend along the X-axial direction. The upstream transport section 7 includes a motor (not shown). Power from the motor is transmitted to the second roller 72. The second roller 72 can be rotated by power from the motor.

The medium 2 is sandwiched between the first roller 71 and the second roller 72. The medium 2 can be transported by rotating the second roller 72 while the medium 2 is sandwiched between the first roller 71 and the second roller 72. The upstream transport section 7 transports the medium 2 toward the platen 8.

In the printing device 1, the second roller 72 is a drive roller, and the first roller 71 is a driven roller. The drive roller is rotationally driven by power from the motor. The driven roller is driven by the rotation of the drive roller. Regarding the first roller 71 and the second roller 72, one of the first roller 71 and the second roller 72 may be a drive roller, and the other may be a driven roller.

Sandwiching the medium 2 between the first roller 71 and the second roller 72 is also referred to as nipping. In the printing device 1, by separating the first roller 71 from the second roller 72, nipping of the medium 2 by the first roller 71 and the second roller 72 can be released.

A nip state and a nip release state are not affected by the presence or absence of medium 2. A state in which the first roller 71 is separated from the second roller 72 regardless of the presence or absence of the medium 2 is the nip release state.

Similarly, regardless of the presence or absence of the medium 2, a state in which the first roller 71 is in contact with the second roller 72 from the nip release state is the nip state. For example, when a new roll 15 is set on the feed shaft 5, nipping is released to allow a leading end of the medium 2 fed from the roll 15 to pass between the first roller 71 and the second roller 72.

The platen 8 is positioned on a −Z direction side of the printing section 3. The platen 8 faces the printing section 3 across the transport path. The platen 8 supports a portion of the medium 2 on which printing is performed by the printing section 3. A support surface 8A, which is a surface facing the +Z direction of the platen 8, is a surface that supports the medium 2. The support surface 8A is substantially horizontal.

The platen 8 is capable of exerting a suction force on the medium 2. A surface of the platen 8 facing the printing section 3 is flat. The support surface 8A of the platen 8 extends across a range in which printing can be performed by the printing section 3. A configuration may be used in which air is sucked by a suction fan from a plurality of suction holes formed in the support surface 8A of the platen 8, and the medium 2 is sucked onto the support surface 8A of the platen 8.

The printing section 3 includes a head 25, a carriage 26, and a guide shaft 27. A plurality of nozzles 28 that eject ink are formed in the head 25. The plurality of the nozzles 28 open into a nozzle surface 25A of the head 25. The guide shaft 27 is a rod-shaped member extending along the X-axial direction. The guide shaft 27 is supported at both end sections in the X-axial direction by a frame or the like (not shown). The guide shaft 27 guides the movement of the carriage 26.

The carriage 26 holds the head 25 and reciprocates the head 25 along the guide shaft 27 in the X-axial direction by driving of a drive mechanism (not shown). The head 25 performs printing on the medium 2 by ejecting ink toward the medium 2 while moving.

The printing section 3 of the present embodiment is a so-called serial printer that performs printing while reciprocating in the X-axial direction, which is the width direction of the medium 2. The printing section 3 may be configured as a so-called line printer including the head 25 in which the nozzles 28 are provided across the width dimension of the medium 2.

In the printing device 1, printing is performed by ejecting ink from the head 25 toward a region of the medium 2 supported by the support surface 8A of the platen 8.

The medium 2 supported by the platen 8 is transported to the downstream support section 10 by the downstream transport section 9. The medium 2 is transported in the +Y direction while being supported by the support surface 8A of the platen 8. The downstream transport section 9 is positioned downstream of the platen 8 in the transport direction. The downstream transport section 9 is positioned upstream of the downstream support section 10 in the transport direction.

The downstream transport section 9 includes a third roller 91 and a fourth roller 92. The third roller 91 and the fourth roller 92 each extend along the X-axial direction. The downstream transport section 9 includes a motor (not shown). Power from the motor is transmitted to the fourth roller 92. The fourth roller 92 can be rotated by power from the motor.

The medium 2 is sandwiched between the third roller 91 and the fourth roller 92. The downstream transport section 9 can transport the medium 2 by rotating the fourth roller 92 while the medium 2 is sandwiched between the third roller 91 and the fourth roller 92. The downstream transport section 9 transports the medium 2 toward the downstream support section 10.

The downstream support section 10 is positioned downstream of the platen 8 in the transport direction. The downstream support section 10 supports a portion of medium 2 on a downstream side in the transport direction with respect to a portion facing the printing section 3.

The winding shaft 12 is positioned downstream of the printing section 3 in the transport direction. The winding shaft 12 winds up the transported medium 2. The winding shaft 12 is positioned downstream of the downstream support section 10 in the transport direction. After the medium 2 is transported along the downstream support section 10, it is wound up by the winding shaft 12.

The upstream heating sections 40 are provided in the upstream support section 6. The upstream heating sections 40 heat the medium 2 supported on a first support surface 61A via the upstream support section 6. The printing heating sections 41 are provided in the platen 8. The printing heating sections 41 heat the medium 2 supported on the support surface 8A via the platen 8. The downstream heating sections 42 are provided in the downstream support section 10. The downstream heating sections 42 heat the medium 2 supported on a downstream support surface 10A via the downstream support section 10.

The blower section 130 is provided at a position facing the downstream support section 10. The blower section 130 can blow an airflow to the medium 2 supported by the downstream support section 10. The blower section 130 can dry ink ejected onto the medium 2 by blowing an airflow onto medium 2.

The control unit 13 controls the entire printing device 1. The control unit 13 may be configured as a circuit that includes one or more processors, one or more dedicated hardware circuits, such as application specific integrated circuits, that perform at least some of the processes, or combinations thereof.

The processor executes various processes according to a computer program. The processor includes a CPU and memories such as a RAM and a ROM. The memory stores program codes or commands configured to cause the CPU to execute the process. Memory or computer readable medium includes any readable medium that can be accessed by a general-purpose or dedicated computer.

For example, the control unit 13 controls the upstream transport section 7 to transport the medium 2 toward the platen 8. The control unit 13 controls the printing section 3 to print an image by ink ejection on a region of the medium 2 supported by the support surface 8A of the platen 8. The control unit 13 controls the winding shaft 12 to cause the winding shaft 12 to wind up the medium 2 on which an image is printed.

The housing 100 defines a portion of the outline of the printing device 1. The housing 100 constitutes a part of the front surface, which is a side surface on a +Y direction side, and a part of the rear surface, which is a side surface on a −Y direction side, of the printing device 1. The housing 100 constitutes a right side surface, which is a side surface on a −X direction side, and a left side surface, which is a side surface on a +X direction side of the printing device 1. The housing 100 constitutes a top surface 100a, which is a surface on a +Z direction side of the printing device 1.

The printing section 3, the upstream transport section 7, the platen 8, the downstream transport section 9, and the control unit 13 are provided inside the housing 100.

The housing 100 may be constituted by a plurality of members. A part of the housing 100 of the present embodiment is constituted by an opening and closing cover 200. The opening and closing cover 200 opens and closes a part of the top surface 100a of the housing 100 by rotating around the axial center of a rotation shaft 250. The axial center of the rotation shaft 250 is along the X-axis, and the rotation shaft 250 extends in the X-axial direction.

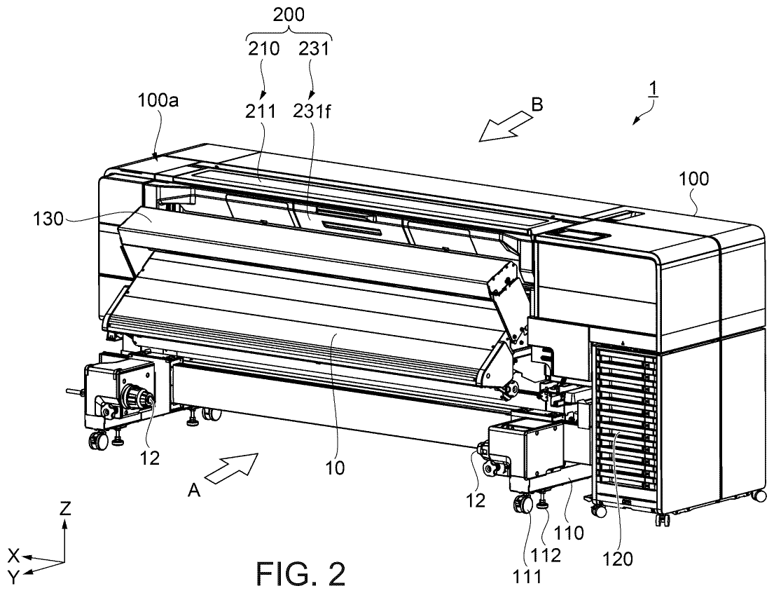

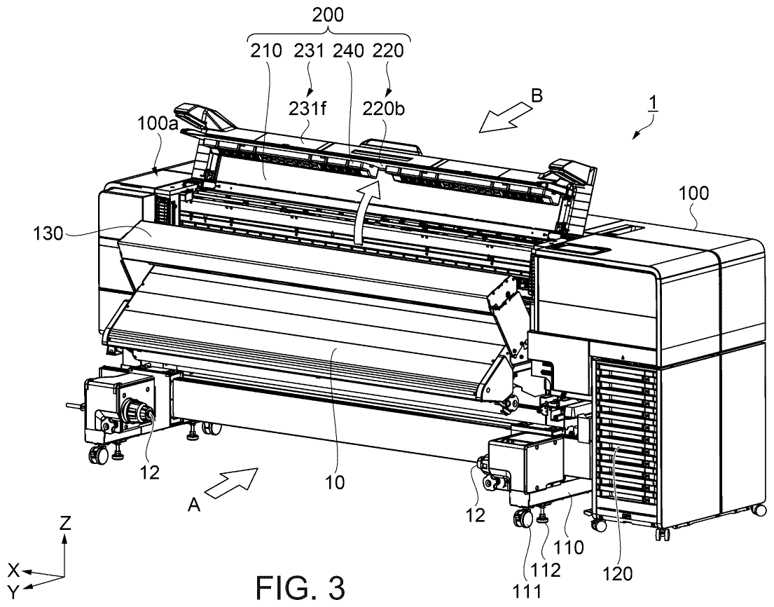

The opening and closing cover 200 is movably provided to move between a closed position (see FIGS. 1 and 2) and an opened position (see FIG. 3) by rotating around the axial center of the rotation shaft 250. The closed position of the opening and closing cover 200 is a position at which the opening and closing cover 200 covers the inside of the housing 100 and constitutes the top surface 100a of the housing 100. The opened position of the opening and closing cover 200 is a position at which the opening and closing cover 200 exposes the inside of the housing 100 and allows an operator to access the inside of the housing 100.

The opening and closing cover 200 constitutes a portion of the front surface of the housing 100 that is vertically above the transport path of the medium 2. The opening and closing cover 200 constitutes a part of the front surface of the top surface 100a of the housing 100, which is vertically above the transport path of the medium 2 and on a −Y direction side from the center in the Y-axial direction.

The opening and closing cover 200 includes a first partition 210 constituting a part of the top surface 100a of the housing 100, and a second partition 220 constituting a part of the front surface of the housing 100.

The first partition 210 constitutes a top surface 100a side of the opening and closing cover 200. The first partition 210 constitutes a part of the top surface 100a of the housing 100. The first partition 210 has a rectangular shape extending in the X-axial direction of the opening and closing cover 200 along the X-Y plane. The first partition 210 includes a window 211.

The window 211 is positioned on a +Z direction side, which is vertically above the support surface 8A of platen 8. The window 211 is positioned on a +Z direction side, which is vertically above a movement region of carriage 26 along the X-axial direction. The window 211 is formed of a member having transparency. By this, in a state in which the opening and closing cover 200 is at the closed position, the inside of the housing 100 is visible from the outside of the housing 100 through the window 211.

The second partition 220 is provided at a position on a +Y direction side that is a front surface side with respect to the center of the first partition 210. The second partition 220 is provided on a −Z direction side of the first partition 210. The second partition 220 has a rectangular shape extending in the X-axial direction of the opening and closing cover 200 along the X-Z plane.

An upper end, which is an end on a +Z direction side, of the second partition 220 is fixed to a surface on a −Z direction side of the first partition 210. A lower end, which is an end on a −Z direction side, of the second partition 220 is positioned on a +Z direction side at a distance from the medium 2 supported by the support surface 8A and the downstream support surface 10A. A duct 231 and a suction section 240 are attached to the second partition 220.

The suction section 240 is fixed to an inner surface 220b of the second partition 220 so as to be able to suck gas 300 inside the housing 100 from a suction hole 241. The inner surface 220b is a surface of the second partition 220 on a −Y direction side that defines a space inside the housing 100. By this, a suction space into which the gas 300 inside the housing 100 is sucked from the suction hole 241 is formed between the suction section 240 and the second partition 220.

The suction section 240 is provided near an upper end of the second partition 220 in the Z-axial direction. The suction section 240 is formed of, for example, a resin member. A bottom surface, which is a surface on a −Z direction side of the suction section 240, is positioned on a +Z direction side of a lower end of the second partition 220. The bottom surface of the suction section 240 is positioned on a +Z direction side of the nozzle surface 25A of the head 25. In the Z-axial direction, the distance between the bottom surface of the suction section 240 and the nozzle surface 25A is longer than the distance between the support surface 8A and the nozzle surface 25A.

The bottom surface of the suction section 240 is positioned on a −Z direction side with respect to an upper end, which is an end on a +Z direction side of a downstream-side side surface of the carriage 26. The downstream-side side surface of the carriage 26 is a side surface on a +Y direction side positioned on a downstream side in the transport direction of the medium 2 among side surfaces of the carriage 26.

The suction section 240 includes the suction hole 241 on a facing surface that is a side surface on a −Y direction side facing the carriage 26. The facing surface of the suction section 240 extends in a stepwise manner in the +Z direction following the bottom surface of the suction section 240. The facing surface of the suction section 240 includes a lower facing surface and an upper facing surface.

The lower facing surface of the suction section 240 is positioned on a +Z direction side of the nozzle surface 25A of the head 25, and is positioned on a +Y direction side, which is downstream in the transport direction with respect to the downstream-side side surface of the carriage 26. The lower facing surface of the suction section 240 faces the downstream-side side surface of the carriage 26. The lower facing surface of the suction section 240 is positioned on a +Y direction side, which is a downstream side in the transport direction with respect to the nozzles 28.

The upper facing surface of the suction section 240 is positioned on a +Z direction side of the lower facing surface, and is positioned on a −Y direction side which is upstream in the transport direction with respect to the downstream-side side surface of the carriage 26. The upper facing surface of the suction section 240 is positioned on a +Y direction side, which is a downstream side in the transport direction with respect to nozzles 28. The suction section 240 includes suction holes 241 in each of the lower facing surface and the upper facing surface.

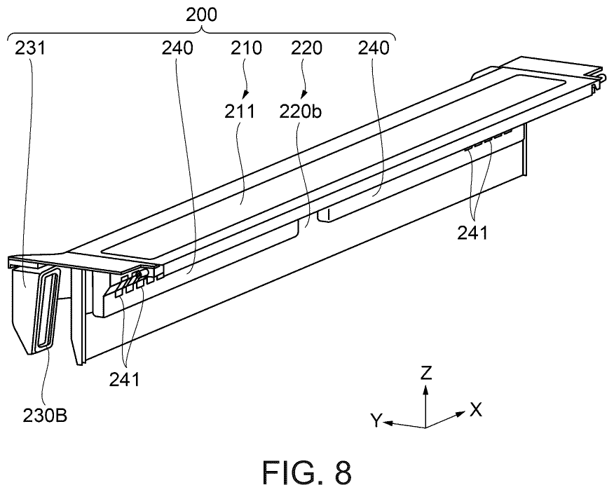

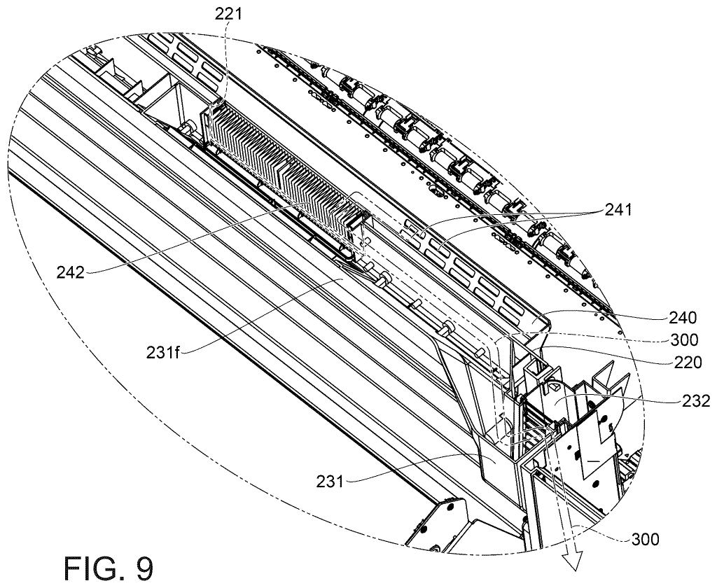

For this reason, when the carriage 26 is not positioned on a −Y direction side, the facing surface of the suction section 240 and the suction holes 241 opening to the facing surface are visible through the window 211. The suction holes 241 are, for example, through holes having a rectangular shape with the X-axial direction as the longitudinal direction (see FIGS. 8 and 9).

The duct 231 is provided near an upper end of the second partition 220 in the Z-axial direction. The duct 231 is provided at a position away from a lower end of the second partition 220 in the +Z direction. The duct 231 is composed of, for example, a resin member. A bottom section, which is an end of the duct 231 on a −Z direction side, is positioned on a +Z direction side of the nozzle surface 25A of the head 25. The bottom section of the duct 231 is positioned on a +Z direction side of a lower end of the second partition 220.

The duct 231 is positioned on a +Y direction side of the second partition 220. A side surface of the duct 231 on a-Y direction side is fixed to an outer surface 220f of the second partition 220, so that the duct 231 is provided on a +Y direction side of the second partition 220. The outer surface 220f is a surface on a +Y direction side among surfaces of the second partition 220. The outer surface 220f is a surface opposite to an inner surface 220b of the second partition 220. The duct 231 extends along the X-axial direction across the opening and closing cover 200 in the X-axial direction.

The duct 231 includes an outer surface 231f that constitutes a part of the front surface of the housing 100. The outer surface 231f is inclined in a direction obliquely downward, including a +Y direction component and a −Z direction component. That is, the outer surface 231f of the duct 231 is inclined downward.

In the outer surface 220f of the second partition 220, a lower end side portion positioned on a −Z direction side with respect to the bottom section of the duct 231 constitutes a part of the front surface of the housing 100. The second partition 220 is formed of a resin member having transparency. By this, when the opening and closing cover 200 is in the closed position, the inside of the housing 100 is visible from the outside of the housing 100 through the lower end side portion of the outer surface 220f.

Furthermore, the outer surface 231f of the duct 231 positioned on a +Z direction side of the lower end side portion of the outer surface 220f is inclined downward. Since the outer surface 231f is inclined downward, the space between the duct 231 and the blower section 130 is widened. By this, in a state in which the opening and closing cover 200 is in the closed position, the inside of the housing 100 is more easily visually recognized from the outside of the housing 100 via the lower end side portion of the outer surface 220f. Since the space between the duct 231 and the blower section 130 is widened, it is easy for a user to access an upstream side of the transport path from the blower section 130, and the workability of necessary work is improved.

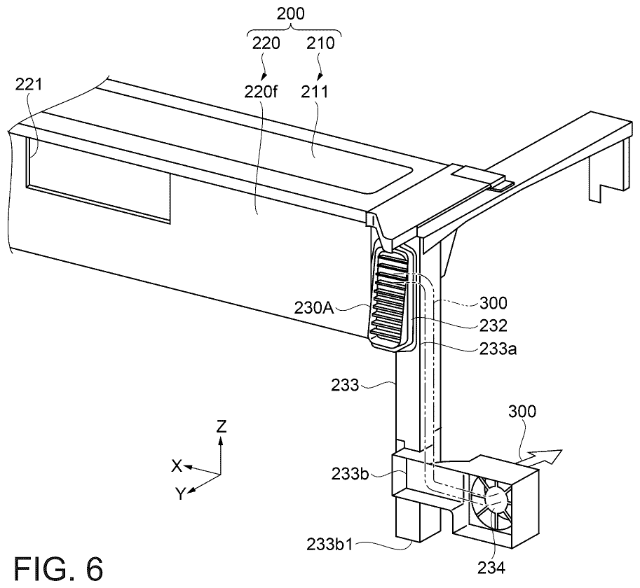

The duct 231 and the suction section 240 are adjacent to each other with a communication section 221 (see FIGS. 1 and 6) provided in the second partition 220 interposed therebetween. The communication section 221 is a path for fluid connecting the duct 231 and the suction section 240. The communication section 221 is a rectangular through hole that penetrates the second partition 220. The communication section 221 may be, for example, a cutout formed by cutting out a part of an upper end of the second partition 220. The internal space of the duct 231 communicates with the suction space of the suction section 240 via the communication section 221.

A filter 242 is provided in the communication section 221 of the second partition 220 so as to close the communication section 221. An end of the filter 242 on a +Y direction side is positioned in the internal space of the duct 231, and an end of the filter 242 on a −Y direction side is positioned in the suction space of the suction section 240.

As shown in FIGS. 2 and 3, leg frames 110 are attached to portions near both ends of the housing 100 in the X-axial direction. Below the leg frame 110, casters 111 and adjusters 112 are provided. By using the casters 111, the printing device 1 can be easily moved. By using adjusters 112, the height of a plurality of places can be adjusted, and the printing device 1 can be suitably installed on an installation surface.

The printing device 1 includes a liquid supply section 120 that supplies ink to the head 25 of the printing section 3. The liquid supply section 120 is configured to be capable of supplying ink to the head 25 via a liquid supply path (not shown).

As described above, the opening and closing cover 200 is provided on a front surface side that is a +Y direction side of the housing 100. As described above, the opening and closing cover 200 includes the first partition 210 constituting a part of the top surface 100a of the housing 100 and the second partition 220 constituting a part of the front surface of the housing 100.

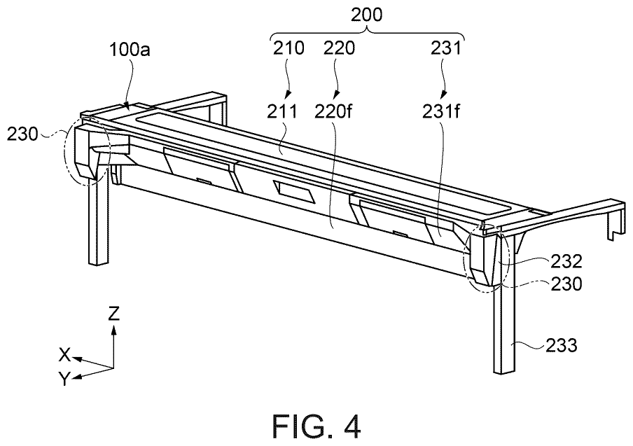

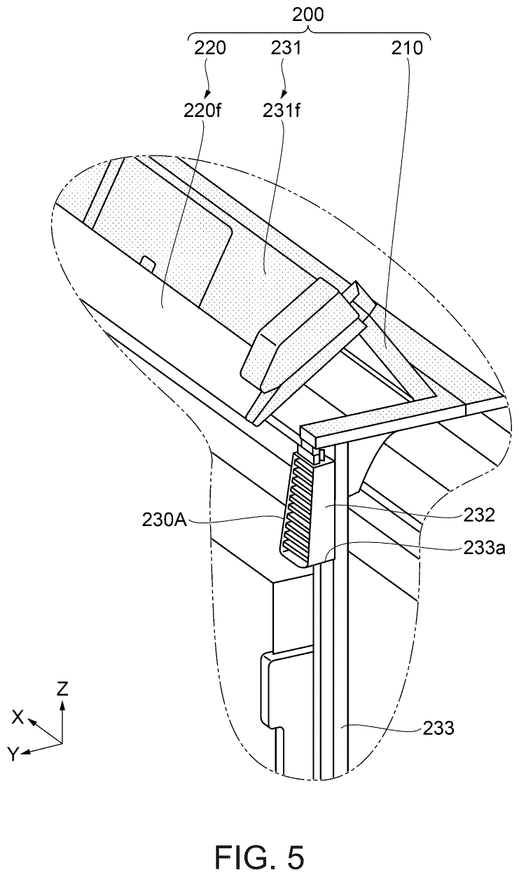

Next, a configuration around the opening and closing cover 200 will be described with reference to FIGS. 4 to 10. FIG. 4 shows the configuration of the opening and closing cover 200 and an inner duct 232 when the opening and closing cover 200 of the housing 100 is in the closed position. FIG. 5 shows the configuration of the opening and closing cover 200 and the inner duct 232 when the opening and closing cover 200 is in the opened position.

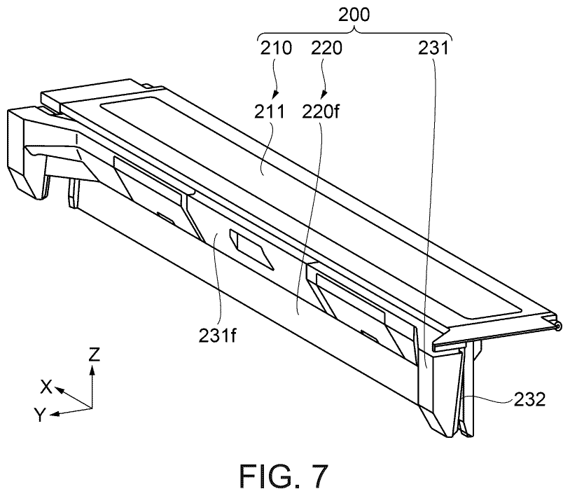

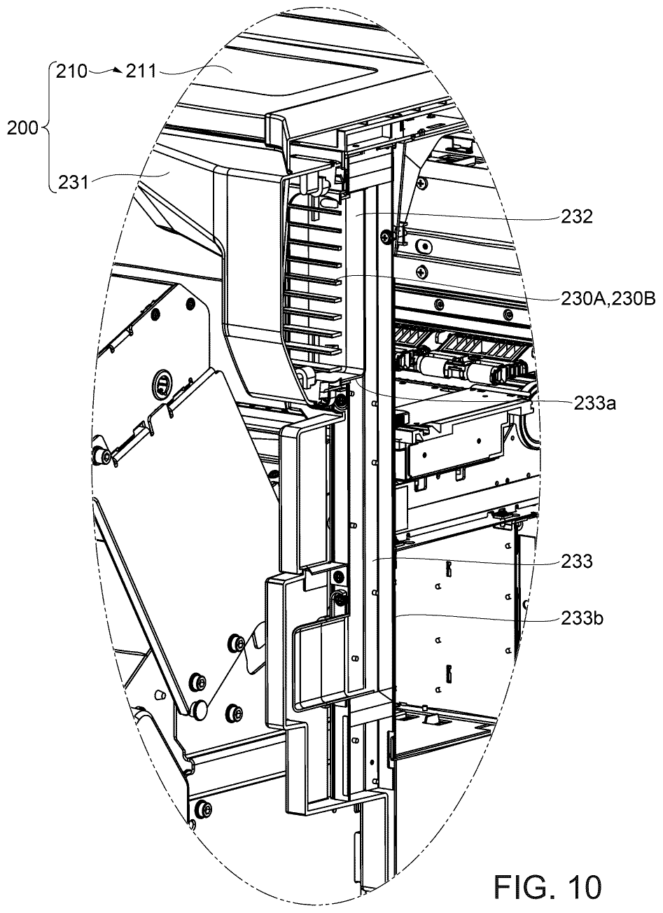

FIG. 6 shows the configuration of the opening and closing cover 200 and the configuration of the inner duct 232 including a vertical duct 233 when constituent members on a +Y direction side of the second partition 220 are removed. FIG. 7 shows the configuration of the opening and closing cover 200 as viewed from a front surface side. FIG. 8 shows the configuration of the opening and closing cover 200 as viewed from a rear surface side. FIG. 9 shows the internal configuration of the duct 231 and the suction section 240 by removing a first partition 210 side of the opening and closing cover 200. FIG. 10 shows a cross-sectional configuration of the inner duct 232 and the vertical duct 233.

As shown in FIGS. 4 and 7, as described above, the opening and closing cover 200 includes the first partition 210 constituting a part of the top surface 100a of the housing 100 and the second partition 220 constituting a part of the front surface of the housing 100.

The duct 231 is fixed to the outside of the second partition 220, that is, on a +Y direction side (see FIG. 9). As shown in FIG. 5, the inner duct 232 communicating with the duct 231 is fixed to the housing 100. As shown in FIG. 4, connecting sections 230 for the connecting the duct 231 and the inner duct 232 is provided at both end sections of the second partition 220 in the X-axial direction.

As shown in FIGS. 8 and 9, the second partition 220 of the opening and closing cover 200 is provided with suction sections 240 that suck the gas 300 inside the housing 100. In the present embodiment, two suction sections 240 are fixed to the inner surface 220b of the second partition 220 side by side in the X-axial direction. Therefore, in the present embodiment, one communication section 221 (see FIGS. 1 and 6) is provided at each of a position on a +X direction side with respect to the center and a position on a −X direction side with respect to the center in the second partition 220.

A plurality of the suction holes 241 of the suction section 240 are provided side by side in the X-axial direction across the width direction of the medium 2 supported by the platen 8 on the facing surface of the suction section 240 described above. In the present embodiment, the suction holes 241 is provided at a position which does not overlap the filter 242 when viewed from the front surface or the rear surface. As a result, the plurality of the suction holes 241 are provided in the suction section 240 so as to sandwich the filter 242 when viewed from the front surface or the rear surface.

“Viewed from the front surface” means viewing as indicated by arrow A in FIGS. 2 and 3, that is, viewing the printing device 1 in the −Y direction from a front surface side that is a +Y direction side. “Viewing from the rear surface” means viewing as indicated by arrow B in FIGS. 2 and 3, that is, viewing the printing device 1 in the +Y direction from a rear surface side that is a −Y direction side.

By ejecting ink from the nozzles 28 of the head 25, liquid fine particles, so-called ink mist, are generated. Liquid fine particles generated in printing on the medium 2 are also diffused to a +Z direction side from the nozzle surface 25A by movement of the carriage 26 in the X-axial direction. By this, liquid fine particles generated in printing on the medium 2 reach a position in the +Z direction from the suction holes 241.

For this reason, the gas 300 that is sucked from the suction holes 241 of the suction section 240 includes liquid fine particles that remain in the housing 100 when ink is ejected onto the medium 2 from the nozzles 28. As described above, the suction section 240 and the duct 231 communicate with each other via the filter 242 provided in the communication section 221.

For example, it is assumed that the control unit 13 controls the printing section 3 in a state in which the opening and closing cover 200 is in the closed position, so that printing is performed on the medium 2 by ejection of ink from the nozzles 28. At this time, the control unit 13 controls an airflow generation section 234 (see FIG. 6) such as an exhaust fan to suck the gas 300 inside housing 100 from the suction holes 241 of the suction section 240.

By this, the gas 300 sucked from the suction holes 241 of the suction section 240 passes through the filter 242 that adsorbs liquid fine particles included in the gas 300. The gas 300 that has passed through the filter 242 passes through the duct 231 and flows into the inner duct 232 via the connecting sections 230 (see FIG. 4). The gas 300 flowing into the inner duct 232 passes through the vertical duct 233 (see FIG. 6), via the airflow generation section 234 (see FIG. 6), and is discharged to the outside of the housing 100.

As shown in FIG. 5, the inner duct 232 includes an inner connection opening section toward the front surface side and is connected to the duct 231. Specifically, the inner connection opening section 230A is inclined so as to face a front surface side and an upper side, that is, the +Z direction. In other words, the inner connection opening section 230A is inclined obliquely upward. As shown in FIG. 8, the duct 231 includes an outer connection opening section 230B configured to be able to come into contact with and separate from the inner connection opening section 230A in accordance with opening and closing of the opening and closing cover 200.

As shown in FIGS. 6 and 10, the inner duct 232 includes the vertical duct 233. The vertical duct 233 is in communication with the airflow generation section 234. That is, the vertical duct 233 is arranged closer to the airflow generation section 234 than the inner connection opening section 230A. In other words, the vertical duct 233 is arranged in the middle of a flow path connecting the inner connection opening section 230A and the airflow generation section 234.

The vertical duct 233 is made of, for example, a hollow angular member. The vertical duct 233 also functions as a frame that constitutes the housing 100.

Since the vertical duct 233 is provided, the printing device 1 can discharge the gas 300 passing through the duct 231 from the suction holes 241 of the suction section 240 to the lower outside of the housing 100 via the vertical duct 233. Therefore, the printing device 1 can remove the gas 300 containing liquid fine particles remaining inside the housing 100.

The vertical duct 233 formed of the hollow angular member can be used as a frame of the housing 100, and the printing device 1 can discharge the gas 300 to a lower side of the housing 100. Further, since the vertical duct 233 functions as a frame, it is possible to reduce the amount of material used, and the printing device 1 can reduce the cost. Furthermore, since the airflow generation section 234 is provided on a vertical duct 233 side, the strength of the opening and closing cover 200 is more easily secured as compared with a case where the airflow generation section 234 is provided on the opening and closing cover 200.

As shown in FIGS. 5 and 6, the vertical duct 233 formed of the angular member includes an upper opening 233a that opens over a plurality of surfaces and a lower opening 233b that is formed below the upper opening 233a and opens over a plurality of surfaces. Specifically, the upper opening 233a, for example, opens over two side surfaces of the angular member extending along the Z direction. The lower opening 233b, for example, opens over two surfaces of the angular member. By providing an opening over a plurality of surfaces, as compared to providing an opening in one surface, it is possible to increase an opening area.

The gas 300 flowing from the inner connection opening section 230A flows into the upper opening 233a. The gas 300 flows out from the lower opening 233b toward the airflow generation section 234. The lower opening 233b is formed above a lower end 233b1 of the angular member.

As described above, since the angular member including the upper opening 233a and the lower opening 233b is used, printing device 1 can discharge the gas 300 in a direction of the airflow generation section 234 while changing a direction of flow of the gas 300 inside the housing 100.

The lower opening 233b is formed above the lower end 233b1. In other words, the vertical duct 233 extends below the lower opening 233b. For this reason, if gas is light like the gas 300, it changes direction and flows out from the lower opening 233b provided in the middle of the vertical duct 233 toward the airflow generation section 234. On the other hand, heavy solid materials or the like fall within the vertical duct 233 to a position lower than the lower opening 233b due to gravity.

In the present embodiment, since the inner connection opening section 230A is inclined obliquely upward, there is a possibility that foreign matter may enter from the inner connection opening section 230A. However, when foreign matter enters from the inner connection opening section 230A, the foreign matter falls below the lower opening 233b and does not flow out toward the airflow generation section 234 when passing through the vertical duct 233. That is, the foreign matter can be caught below the lower opening 233b in the vertical duct 233. As a result, it is possible to reduce the contact of the entering foreign matter with the airflow generation section 234, and to reduce the occurrence of failure.

The configuration of a flow path through which the gas 300 inside the housing 100 is sucked and discharged to the outside of the housing 100 on a +X direction side with respect to the center of the printing device 1 includes substantially the same flow path configuration as that on a −X direction side with respect to the center of the printing device 1 described above. Independent flow paths may be formed on a −X direction side and a +X direction side from the center of the printing device 1, and the gas 300 inside the housing 100 may be discharged to the outside of the housing 100.

As described above, according to the printing device 1 of the first embodiment, the following effects can be obtained.

The printing device 1 includes the head 25 that is accommodated in the housing 100 and ejects ink onto the medium 2. The printing device 1 includes the opening and closing cover 200 that includes the first partition 210 constituting a part of the top surface 100a of the housing 100 and the second partition 220 constituting a part of the front surface of the housing 100, and opens and closes the top surface 100a of the housing 100. The printing device 1 includes the suction section 240 that suctions the gas 300 inside the housing 100 from the suction hole 241, and the duct 231 that communicates with the suction section 240. The duct 231 is fixed to the outer surface 220f of the second partition 220.

According to this configuration, since the duct 231 is fixed to the outer surface 220f of the second partition 220, the strength of the opening and closing cover 200 is easily secured as compared with a case where the duct 231 is provided at a lower end of the second partition 220.

The suction section 240 is fixed to the inner surface 220b of the second partition 220 and communicates with the duct 231 via the communication section 221 provided on the second partition 220. According to this configuration, since the suction section 240, which communicates with the duct 231 via the communication section 221, is fixed to the inner surface 220b of the second partition 220, it is easy to secure the strength of the opening and closing cover 200.

The first partition 210 includes the window 211 through which the inside of the housing 100 is visible, and the suction section 240 is provided so as to be visible through the window 211. According to this configuration, the suction section 240 can be visually recognized in a state in which the opening and closing cover 200 is closed.

The printing device 1 includes the filter 242 arranged in the duct 231, and the suction hole 241 is provided at a position that does not overlap with the filter 242 when viewed from the front surface. According to this configuration, when the opening and closing cover 200 is in the opened position, the filter 242 contaminated by collecting liquid fine particles contained in the gas 300 inside the housing 100 is less likely to be visually recognized.

When viewed from the front surface, the plurality of the suction holes 241 are provided so as to sandwich the filter 242. According to this configuration, since the plurality of the suction holes 241 are provided, the gas 300 inside the housing 100 can be efficiently sucked.

The second partition 220 is formed of a member having transparency, and the duct 231 is provided at a position away from a lower end of the second partition 220. According to this configuration, when the opening and closing cover 200 is in the closed position, the inside of the housing 100 can be visually recognized through the second partition 220.

The duct 231 includes the outer surface 231f constituting a part of the front surface of the housing 100, and the outer surface 231f is inclined downward. According to this configuration, when the opening and closing cover 200 is in the closed position, it is easier to visually recognize the inside of the housing 100 through the second partition 220.

The printing device 1 according to the above-described embodiment of the present disclosure essentially includes the configuration as described above, but it is of course possible to change or omit parts of the configuration within the scope that does not depart from the essence of the present disclosure. The above-described embodiment and other embodiments described below can be implemented in combination with each other to the extent that they are not technically contradictory. Hereinafter, other embodiments will be described.

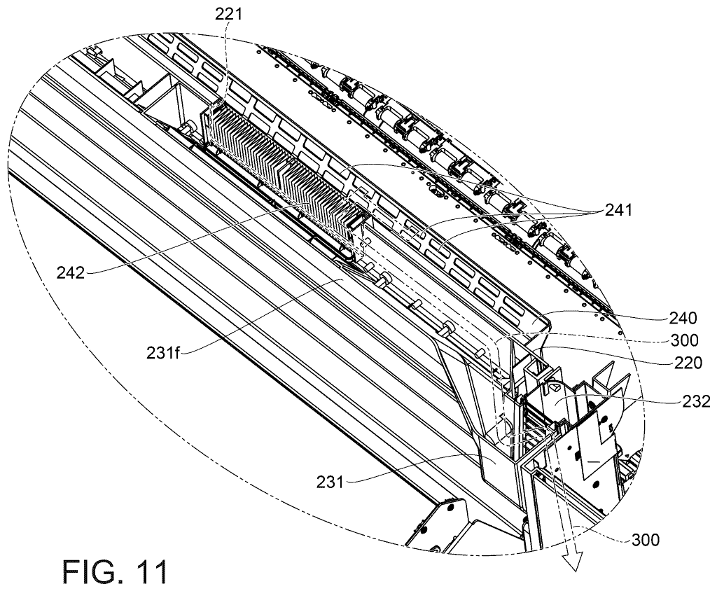

In the above-described embodiment, the suction hole 241 of the suction section 240 may be provided at a position overlapping with the filter 242 when viewed from the front surface. For example, as shown in FIG. 11, a plurality of suction holes 241 may be provided across the X-axial direction of a facing surface of the suction section 240, including positions overlapping with the filter 242 when viewed from the front surface.

In this case, the suction hole 241 having a shape different from that of the suction hole 241 provided at a position not overlapping with the filter 242 may be provided at a position overlapping with the filter 242 when viewed from the front surface. For example, as shown in FIG. 11, the suction hole 241 larger than the suction hole 241 provided at a position not overlapping with the filter 242 may be provided at a position overlapping with the filter 242 when viewed from the front surface.

In the above-described embodiment, the plurality of communication sections 221 may not be provided in the second partition 220. For example, one communication section 221 may be provided at the center of the second partition 220 in the X-axial direction. In this case, one suction section 240 may be provided across the X-axial direction of the second partition 220.

In the above-described embodiment, the suction hole 241 of the suction section 240 may be provided on a bottom surface of the suction section 240. In this case, the suction hole 241 may be provided on the facing surface of the suction section 240 in addition to the bottom surface of the suction section 240, or may not be provided on the facing surface.

In the above-described embodiment, in the duct 231, in addition to the side surface of the duct 231 on a −Y direction side being fixed to the outer surface 220f of the second partition 220, a side surface of the duct 231 on a +Z direction side may be fixed to the first partition 210.

In the above-described embodiment, the internal space of the duct 231 may be formed by the duct 231 and the outer surface 220f of the second partition 220. In this case, in the duct 231, a side surface of the duct 231 facing the +Z direction may be fixed to the first partition 210, and a bottom section of the duct 231 may be fixed to the outer surface 220f of the second partition 220. In this case, a side surface of the duct 231 on a −Y direction side may be omitted.

What is claimed is:

1. A printing device comprising:
a head that is accommodated in a housing and that ejects liquid onto a medium;
an opening and closing cover that includes a first partition constituting a part of a top surface of the housing and a second partition constituting a part of a front surface of the housing, and that opens and closes the top surface of the housing;
a suction section that sucks gas inside the housing from a suction hole; and
a duct that communicates with the suction section, wherein
the duct is fixed to an outer surface of the second partition.

2. The printing device according to claim 1, wherein
the suction section is fixed to an inner surface of the second partition and communicates with the duct via a communication section provided in the second partition.

3. The printing device according to claim 2, wherein
the first partition includes a window through which an inside of the housing is visible and
the suction section is provided so as to be visible through the window.

4. The printing device according to claim 2, further comprising:
a filter arranged in the duct, wherein
when viewed from the front surface, the suction hole is provided at a position that does not overlap with the filter.

5. The printing device according to claim 4, wherein
when viewed from the front surface, a plurality of the suction holes are provided so as to sandwich the filter.

6. The printing device according to claim 1, wherein
the second partition is formed of a member having transparency and
the duct is provided at a position away from a lower end of the second partition.

7. The printing device according to claim 6, wherein
the duct includes an outer surface that forms a part of the front surface of the housing and
the outer surface is inclined downward.
